(19) United States
(12) Patent Application Publication
(10) Pub. No.: US 2015/0294383 A1
(43) Pub. Date: Oct. 15, 2015

(54) ONLINE BIDDING MANAGEMENT SYSTEM

(71) Applicant: BACKBID INC., Montreal (CA)

(72) Inventors: Danny ROSENOFF, Montreal (CA); Ashraf ZAID, Montreal (CA); Christopher PATRIDGE, Beaconsfield (CA)

(21) Appl. No.: 14/746,906

(22) Filed: Jun. 23, 2015

Related U.S. Application Data
(63) Continuation of application No. 13/622,625, filed on Sep. 19, 2012.
(60) Provisional application No. 61/536,113, filed on Sep. 19, 2011.

(51) Int. Cl. G06Q 30/06

(52) U.S. Cl. CPC G06Q 30/0611; G06Q 30/0609

(57) ABSTRACT

There is described an online bid management system where a consumer may post a receipt for a purchase or an intent to purchase a product or service and receive bids for equivalents to the original product or service from a series of merchants. The system acts as a filter between the consumers and the merchants. The posted receipts are initially filtered for the merchants such that only merchants that offer equivalents to the original product or service are provided with any given posted receipt. Similarly, the bids received by the merchants in response to a given original product or service are also filtered for the consumer such that only offers that are truly a “better offer” are presented to the consumer. The information is therefore processed in both directions, and is streamlined for the needs of both the merchants and the consumers.

### CROSS-REFERENCE TO RELATED APPLICATIONS

The present application is a continuation application of U.S. application Ser. No. 13/622,625, filed on Sep. 19, 2012, which claims priority under 35 U.S.C 119(e) of U.S. Provisional Patent Application No. 61/536,113 filed on Sep. 19, 2011, the contents of which are hereby incorporated by reference.

### TECHNICAL FIELD

The present invention relates to the field of product comparison and more particularly, to online bidding by merchants offering consumers a better deal for an equivalent of a given purchase.

### BACKGROUND OF THE ART

Various websites exist to allow consumers to compare prices among different merchants. Some examples are Expedia™ and Travelocity™, which provide listings of flights, hotels and other travel services from multiple service providers. Such websites enable a direct comparison between products and services offered by the different merchants. Products and services may be sorted by price or using another criteria.

Regrouping all of the participating merchants' offers in one place is very useful to reduce the time required by the consumer to find the information for each merchant and perform a manual comparison. However, in many cases, the information is still quite voluminous. Such systems do not necessarily process the data such that it can more easily be digested by the consumer. In addition, while some systems attempt to personalize the results provided to a user based on a set of preferences or a user history, past preferences are not necessarily representative of present needs.

Therefore, there is a need to improve on product comparison systems in terms of efficiency and/or utility.

### SUMMARY

There is described herein a system to be used by consumers who make a purchase or intend on making a purchase and would like to obtain a better deal for a comparable product or service. The original product or service may be a hotel reservation, an electronic consumer good, a trip, a food item, or any other product or service whereby comparables and non-comparables exist. For example, in the case of a hotel room, a comparable would be a room in another hotel of similar or slightly better quality (ex. 3 stars) while a non-comparable would be a room in another hotel of inferior or excessively superior quality (ex. 1 star or 5 stars). For an electronic consumer good such as a computer, a comparable would have similar or slightly better characteristics and features while a non-comparable would have inferior or excessively superior characteristics and features.

Using the online system, a consumer may post a receipt for a purchase or provide details regarding an intended purchase and receive bids for comparables to the original product or service from a series of merchants. A comparable product or service is defined as equivalent or better. The system acts as a filter between the consumers and the merchants. The posted receipts may initially be filtered for the merchants such that only merchants that offer comparables to the original product or service are provided with any given posted receipt. Similarly, the bids received by the merchants in response to a given posted receipt are also filtered for the consumer such that only offers that are truly a “better offer” are presented to the consumer. Filtering bid requests is useful to ensure that merchants are not inundated with requests for bids that are irrelevant to their business and their products/services. Filtering merchant bids is useful to ensure that the consumers feel they receive valuable feedback and do not need to “hunt” for the truly interesting bids amongst a mountain of data. The information is therefore processed in both directions, i.e. from the consumer to the merchant and from the merchant to the consumer, and is streamlined for the needs of both the merchants and the consumers.

The original product or service and bids may be compared on multiple levels, not just with regards to price. A bid for a computer that is acceptable to be presented to a consumer may need to have equivalent memory storage space, processor speed, display resolution features, etc. The complexity level of the comparison may be increased if various features of the computer are provided with differing weights in order to determine whether the bid is a “better deal”. For example, a computer having all of the same characteristics but with a lot more memory while costing only a little bit more may be considered to be a “better deal” and the bid may be presented to the consumer.

In accordance with a first broad aspect, there is provided a computer-implemented method for managing competing bids from multiple merchants for an original product or service. The method comprises receiving information regarding the original product or service. Potential merchants suitable for providing a competing bid to the original product or service are identified. Selected merchants are advised of the original product or service open for bidding. Bids from the selected merchants are assessed in accordance with a set of predetermined criteria, and only accepted bids are provided for consideration.

In accordance with another broad aspect, there is provided a system for managing competing bids from multiple merchants for an original product or service, the system comprising at least one computer server communicable with at least one client computing device over a network, the server having a processor and a memory having executable program code stored thereon and executable by the server. The program code comprises instructions for receiving information regarding the original product or service. Potential merchants suitable for providing a competing bid to the original product or service are identified. Selected merchants are advised of the original product or service open for bidding. Bids from the selected merchants are assessed in accordance with a set of predetermined criteria, and only accepted bids are provided for consideration.

In accordance with yet another broad aspect, there is provided a computer readable medium having encoded thereon: program code of a bid management module executable by a processor to receive information regarding an original product or service, identify potential merchants suitable for providing a competing bid to the original product or service, and advise selected merchants of the original product or service open for bidding; and program code of a bid assessment module executable by a processor to assess bids from selected merchants in accordance with a set of predetermined criteria and provide only selected bids for consideration.

There is also provided a method for extracting information from a document without knowing the specific format of that document, and a method for building scalable interactive and iterative searches and queries on large databases that expose the search results and the effect of the specified criteria on these results.

### BRIEF DESCRIPTION OF THE DRAWINGS

Further features and advantages of the present invention will become apparent from the following detailed description, taken in combination with the appended drawings, in which:

FIG. 1 is a flowchart illustrating an embodiment of a method for processing bids in a bidding management system;

FIG. 2 is a flowchart illustrating an embodiment of the step of receiving new posts from the flowchart of FIG. 1;

FIG. 3 is a flowchart illustrating an embodiment of the step of identifying potential merchants from the flowchart of FIG. 1;

FIG. 4 is a flowchart illustrating an embodiment of the step of searching for bids from non-partner merchants from the flowchart of FIG. 1;

FIG. 5 is a flowchart illustrating an embodiment of the step of assessing bids from the flowchart of FIG. 1;

FIG. 6 is a schematic illustration of a system for executing the bidding management system in accordance with one embodiment;

FIG. 7 is a block diagram illustrating an exemplary application running on the processor of the system of FIG. 6;

FIG. 8 is a block diagram illustrating an exemplary bid management module of FIG. 7; and

FIG. 9 is a block diagram illustrating an exemplary bid assessment module of FIG. 7.

It will be noted that throughout the appended drawings, like features are identified by like reference numerals.

### DETAILED DESCRIPTION

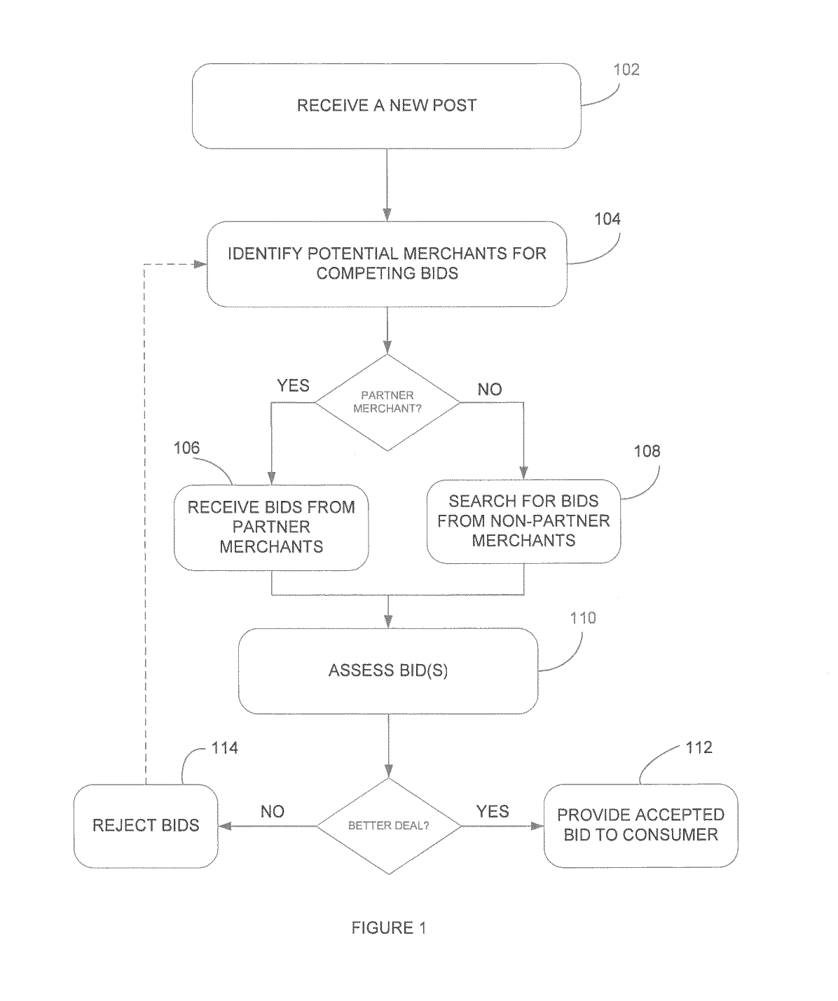

Referring to FIG. 1, there is illustrated a flowchart of an exemplary processing method for a bidding management system. The bidding system acts as an intermediary between consumers and merchants and provides various filtering mechanisms to convey information to both the merchants and the consumers only when the information is relevant. In a first step 102, new posts are received by the bidding management system. Posts correspond to purchases made by consumers and for which the consumer would like to obtain competing bids. The purchases may fall into a wide variety of categories, including products and services. Products may be any type of consumer good available for purchase by the public. In some embodiments, the system may be adapted to also handle goods available to distributors from manufacturers, either individually or in bulk. Services may be from the travel industry (hotels, flights, car rentals, etc), the entertainment industry (tickets to shows, plays, concerts), the leisure industry (massages, rounds of golf, museum visits, restaurants), or any other industry whereby a service may be offered by more than one merchant.

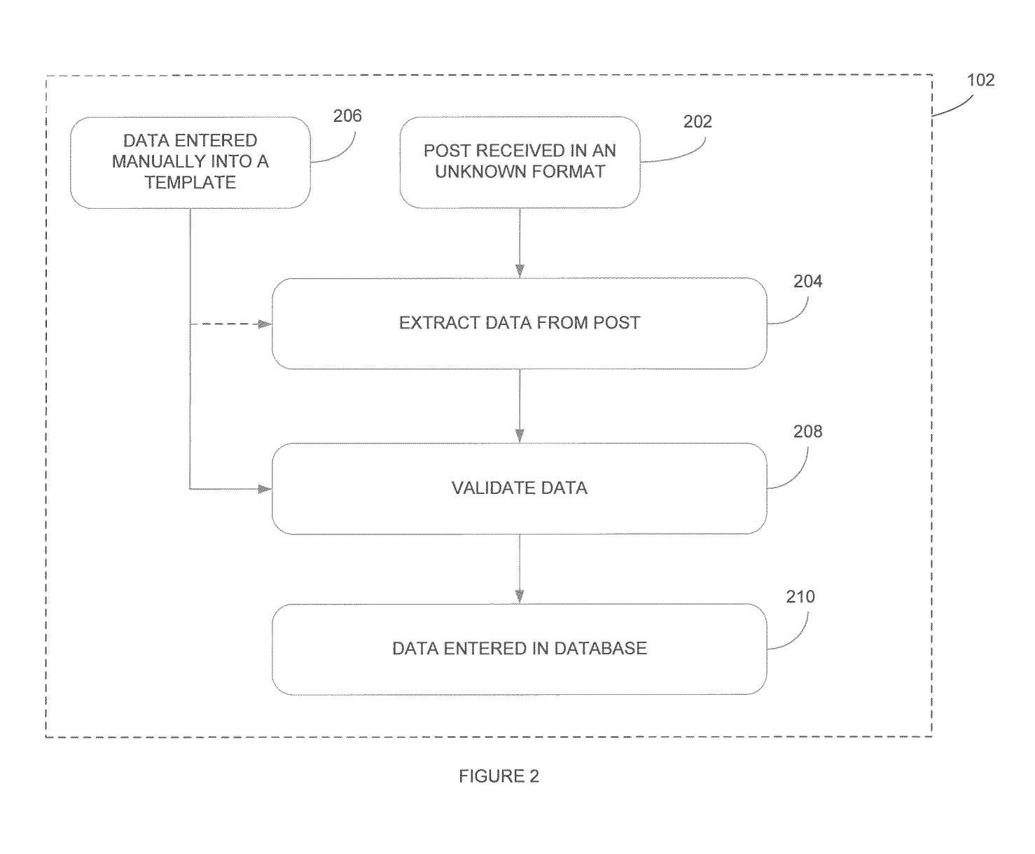

FIG. 2 illustrates an exemplary method for receiving new posts 102. They may be received in various unknown formats 202. For example, posts may be received in an email. The email may contain a purchase confirmation from an original merchant or it may contain a consumer-provided description of the purchase. The data describing the purchase may be contained directly in the body of the email or it may be in a document attached to the email having a given format, such as PDF, JPEG, DOC, etc. The data may also come from a third party application or from a third party website, such as a social media website. Data regarding the purchase is extracted from the received post 204.

In some embodiments, the system is configured to accept only certain types of documents or certain formats, in order to facilitate parsing of new postings and extracting of data. Alternatively, the system may be configured to make abstraction of the different formats/layouts and the changing nature of these formats by using a parsing model that does not rely on advanced knowledge of the format or the layout to extract specific pieces of information automatically. In this embodiment, the parsing model may be configured to closely mimic human behavior when reading and understanding a specific document. A person reading a document does not look at the formatting but rather at the rendered copy of the document. The parsing model therefore converts the file to a page description language (PDL) format (ex: PostScript, XPS or similar formats) such that the content is laid out in blocks and each block contains the data to be rendered as well as the location of this data.

The original file or document may be converted to a PDL format using an editing application appropriately selected for the document type. The document type may be identified using the mime type or the extension of the file. Some editing applications provide functions to export to XPS or PostScript. If this is not available, a Windows™ XPS Printer driver may be used to produce XPS files. The converted file (in a rendered format) is then loaded as an object tree. Each block may be searched for a keyword or an equivalent thereof. When a keyword is found, it is identified as a keyword block. The parsing model is then adapted to look for all blocks that when printed will either appear to the right (or left depending on the text language direction) or below the keyword block, thus finding the text that visually will appear to the user next to the sought after keyword without any consideration to where it was in the content of the original document. These elements are added to the list of found values.

When multiple values are found in close proximity of the keyword block, all of them are added to the pool of values. If more than one block is found for the same sought after keyword, all corresponding values are added to the same pool of values. The pool is then scanned to determine the one value that is most appropriate for selection. The expected data format (dates, numbers, address, etc), as well as their relations to other values already extracted, allow the system to select the appropriate one.

Once all relevant data has been extracted from a post, it is validated 208 and stored in a database 210. In some embodiments, the data may be entered directly on a webpage of a proprietary website in a manual fashion 206. In such a case, various templates may be provided for direct entry, thereby clearly indicating the information required to provide competing bids and facilitating data extraction and/or validation.

The system may be adapted to function with actual purchases and/or intent to purchase. In some embodiments, the consumer may express to the system his intent to purchase the product or service without actually having purchased it. In that case the data describing the product, a link to a public description of the product on another site, the UPC, or any similar identifier of the product may be entered directly on a webpage of a proprietary website in a manual fashion or forwarded to the system in an e-mail. In such a case, all other aspects of the system described herein are executed in similar fashion to when an actual purchase is being processed.

Some exemplary matter specific properties used in order to describe the original item purchased by the consumer are listed in TABLE 1. Many of these properties may be used during the comparison offer. Note that the examples illustrated in the table are for a purchase corresponding to a hotel reservation. The properties may differ for other types of purchase.

TABLE 1

| # | Property | Description |
|---|---|---|
| 1 | CheckInDate | The check-in date for the hotel |
| | | reservation. |
| 2 | CheckOutDate | The check-out date for the hotel |
| | | reservation. |
| 3 | RoomsCount | Number of rooms reserved. |
| 4 | AdultsCount | Total number of adults in the |
| | | reserved rooms. |
| 5 | ChildrenCount_0_12 | Total number of children aged 12 and |
| | | less in the reserved rooms. |
| 6 | ChildrenCount_13_17 | Total number of children aged between |
| | | 13 and 17 in the reserved rooms. |
| 7 | RoomType | Internal categorization for the type of |
| | | the reserved room. |
| 8 | BedType | Internal categorization for the type of |
| | | beds in the reserved room. |
| 9 | AdjRooms | Specify if it is required to have |
| | | adjacent rooms. |
| 10 | Hotel | Identify the original hotel or merchant. |
| 11 | HotelConfirmationNumber | The confirmation number of the |
| | | original reservation. |
| 12 | DestinationAreaId | The area the consumer is traveling to. |
| 13 | AverageRate | Average daily rate for a single |
| | | reserved room. |
| 14 | DailyRates | Detailed daily rates for each day |
| | | of the stay. |
| 15 | TravelReason | Indicate if the travel is for |
| | | business or leisure. |

Table 2 is an exemplary set of administrative properties, also stored in the database with regards to new posts, and used to manage and implement various algorithms in the system.

TABLE 2

| # | Property | Description |
|---|---|---|
| 1 | PostId | Uniquely identify a post within |
| | | the system. |
| 2 | Consumer | Identify the consumer, owner |
| | | of the post. |
| 3 | PostedDateTime | The date and time when the Post was |
| | | added to the database. |
| 4 | IsActive | Specify if the post is active |
| | | within the system. Has |
| | | not been cancelled by the consumer. |
| 5 | IsOpenForBids | Specify if the system can still accept/ |
| | | create new bids for that post. |
| 6 | AcceptedBid | Specify if the consumer has already |
| | | accepted a bid for that post. |
| 7 | EndofBidsDateTime | Determine the latest date and time |
| | | that the system can accept/create |
| | | bids for that post. Usually |
| | | represent the cancellation date time |
| | | for the original purchase. |
| 8 | RequiredFeatures | Identify the list of features required |
| | | by the consumer to be in the offer |
| 9 | PostSourcePartyId | Identify the party where the post |
| | | originated from |
| 10 | PostSourceData | Optional data passed from the |
| | | originating party to be used when |
| | | communicating with that party |
| | | regarding the post. |
| 11 | IdAtSource | Internal ID of the post within the |
| | | originating party system. |
| 12 | AcquisitionCost | Cost of the acquisition of the post. |
| | | Zero for post@domain-name.com. |
| | | Equivalent to any referral |
| | | fees to be paid or original commission |
| | | to be reimbursed when the consumer |
| | | accepts a competing bid. |
| 13 | AutoBidSearchsCount | The number of automatic searches |
| | | done for this post on the global |
| | | inventory databases to find better |
| | | deals. |
| 14 | AutoBidLastSearchDateTime | The date and time of the last automatic |
| | | search done for this post on the |
| | | global inventory databases to find |
| | | better deals. |
| 15 | MinRating | Minimum rating of competing |
| | | merchants accepted by the consumer. |
| 16 | Channel | Categorization for how the original |
| | | purchase was done. |
| 17 | BidsCount | Total number of bids offered |
| | | to this post. |

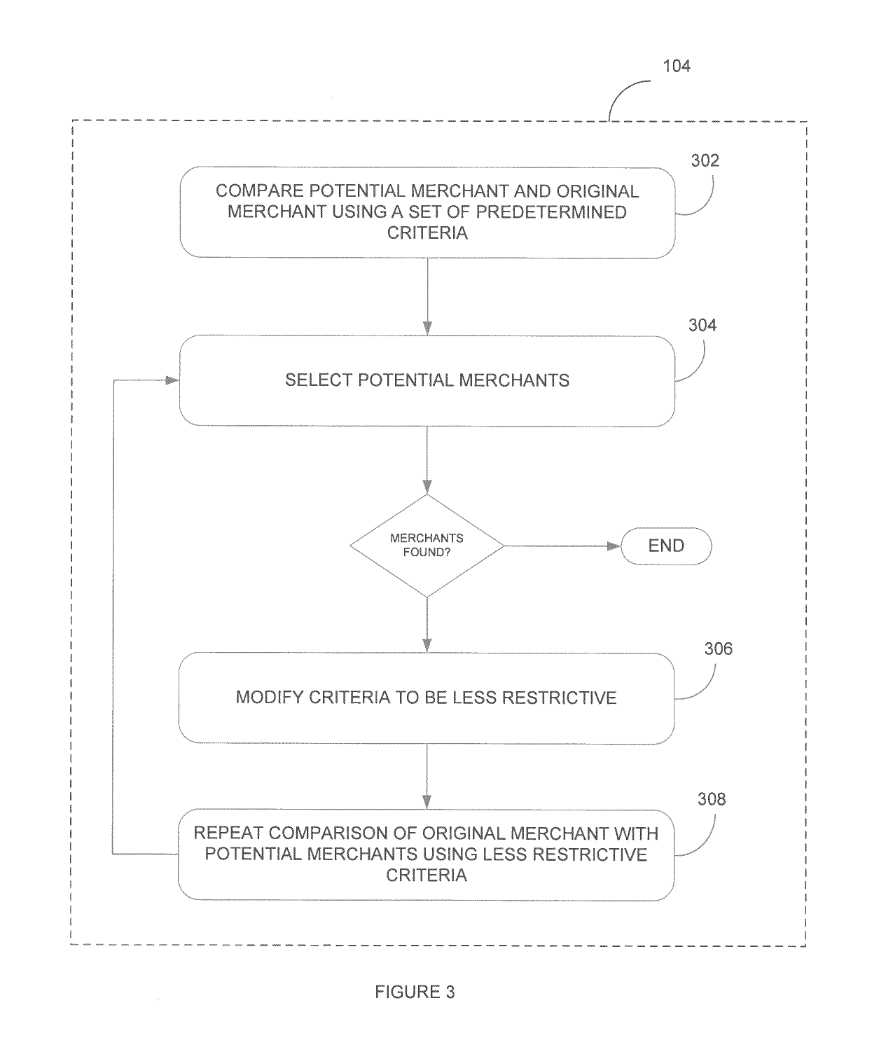

Referring back to FIG. 1, after a new post is received, potential merchants are identified as candidates for competing bids 104. FIG. 3 illustrates an exemplary method for identifying potential merchants. In a first step, potential merchants are compared to the original merchant using a set of predetermined criteria 302. A merchant may not be found to be a candidate for a competing bid for a post that does not correspond to a product or service offered by the given merchant. In addition, merchants having no interest in bidding for certain types of posts or that cannot provide competing bids to the consumer may not be found to be candidates.

Some exemplary predetermined criteria that may be considered when searching for potential merchants are the geographical distance between the original merchant and the new merchant, a rating of the new merchant compared to a minimum acceptable rating by the consumer or compared to the original merchant's rating, the types of products/services offered by the new merchant, and statistical or historical data regarding past competing bids offered by the new merchant. Other criteria may also be considered and the criteria considered may differ as a function of the type of products or services being compared. For example, if the product is a hotel reservation, a star rating for the hotel may be considered. This criteria would not be appropriate for a consumer good, such as a mobile device. The system may be adapted to select a set of predetermined criteria in accordance with purchase type.

The process of selecting the allowed merchants may be an iterative process. After a first comparison with the set of predetermined criteria 302, potential merchants are selected 304. If sufficient merchants are found, the process may end there. If an insufficient number of merchants are found, the criteria may be modified to allow for a broader pool of candidates 306. The comparison of the original merchant may be repeated with the modified criteria 308. In one embodiment, the system starts with the most restrictive (and preferable) values for its criteria, relaxes one of the values, and repeats the process until either it finds enough matching merchants or it reaches the lowest possible allowed value for each parameter and stops.

The step of identifying potential merchants for competing bids 104 is the first line of filter against unacceptable offers reaching the consumer. It prevents an unqualified merchant from sending bids to consumers that would be irrelevant or considered noise and spam. As per FIG. 1, potential merchants identified via step 104 may be partner merchants (step 106) or non-partner merchants (step 108). Partner merchants are merchants that actively use the system to customize bids as a function of received posts. Such bids may be made in a direct and private manner using predefined templates provided to the partner merchants.

An exemplary predefined template for partner merchants may contain the following:
1. Query: a set of criterions that specify the rules to use when identifying the targeted consumers, products and competing merchants.
2. The details of the competing bid, either as a discount, added value(s), upgrades, etc.
3. The rules to manage the inventory and availability of units to be sold under this offer.
4. The duration of the offer and its expiration rules.

The query may be defined separately from the rest of the bid template, such that it can be reused many times with many bid templates. Queries are saved to a database and the following exemplary general properties may be used to manage and execute them:

TABLE 3

| # | Property | Description |
|---|---|---|
| 1 | QueryId | Uniquely identify a query within the system. |
| 2 | PartnerUser | Identify the user, owner of the query. |
| | | The query can be shared with other users |
| | | working for the same merchant |
| | | organization. |
| 3 | QueryName | The name of the query used within |
| | | the system. |
| 4 | QueryDescription | A long description for the query. |
| 5 | IsActive | Specify if the query is active |
| | | within the system. |
| | | Has not been deleted by the user. |
| 6 | Merchant | Identify the partner merchant using this query. |
| 7 | TargetCompSet | Identify the specific comp set |
| | | (merchants, markets and |
| | | areas) that will be targeted by this query. |
| 8 | TargetAreas | Identify the list of markets and areas to |
| | | target by this query. |
| 9 | TargetAreaMinRating | Specify the minimum merchant |
| | | rating to target within the |
| | | targeted markets and areas. |
| 10 | TargetMerchants | Identify the list of merchants to |
| | | target by this query. |
| 11 | TargetDates | Specify the type of date range to use for the |
| | | query (Relative: next 2 weeks . . . Fixed: |
| | | Oct. 21, 2011 to Oct. 31, 2011 . . . or |
| | | floating: the period starting in 10 |
| | | days for the duration of 20 days . . . ). |
| 12 | DaysSpecifications | Specify which days of the week to target. |
| 13 | MinEducationLevel | Lowest consumer education level to consider |
| 14 | MinIncomeRange | Lowest consumer income range to consider |
| 15 | RatePlans | Specify consumer's category and associations |
| | | to consider (Government, Military . . . ). |
| 17 | Channels | Specify which original purchase |
| | | channels to target. |
| 16 | MinConsumerLevel | Specify the minimum consumer |
| | | rating to consider. |
| 18 | LastUsedDateTime | The date time of the last used. |

In addition to these general properties stored for each query in the database, there are also matter specific properties that describe the matter. Many of these properties may be used during the execution of queries. Table 4 lists, as an example, some matter specific properties kept by the system for a hotel reservation query.

TABLE 4

| # | Property | Description |
|---|---|---|
| 1 | TargetRoomTypes | Using internal categorization to target |
| | | specific types of reserved rooms. |
| 2 | MinCheckInDate | Earliest check in date of a hotel |
| | | reservation to consider in the query. |
| 3 | MaxCheckInDate | Latest check in date of a hotel |
| | | reservation to consider. |
| 4 | MinNightsCount | Lowest number of nights of stay. |
| 5 | MaxNightsCount | Highest number of nights of stay. |
| 6 | MinAverageRate | Lowest average nightly rate. |
| 7 | MaxAverageRate | Highest average nightly rate. |
| 8 | MaxAdultsCount | Highest number of adults on a reservation. |
| 9 | MaxChildrenCount_0_12 | Highest number of children 12 years old |
| | | or less on a reservation. |
| 10 | MaxChildrenCount_13_17 | Highest number of children 13 to 17 |
| | | years old on a reservation. |
| 11 | MinRoomsCount | Lowest number of rooms reserved. |
| 12 | MaxRoomsCount | Highest number of rooms reserved. |
| 13 | TravelReason | Indicate the type of travel to consider. |
| 14 | AdjRoomsPreference | Specify if it is required to have |
| | | adjacent rooms. |
| 15 | MinNightsPerYear | Specify the minimum nights |
| | | of travel per year for |
| | | consumers to be considered by this query. |

In one embodiment, a property not entered is assumed to include all allowed values and is not checked. During execution of a query, the system may generate an SQL statement that includes all the criteria and executes that statement on the database, then returns the results of the query to the calling process.

Partner merchants may have customized accounts in the bidding system. Customized accounts may include various access rights to different parts of the system, personalized bidding preferences, and priorities on certain types of bids. In some embodiments, partner merchants may specify a preference as to whether they want to bid on posts related to actual purchases, posts related to an intent to purchase, or both. In addition, partner merchants may be provided with additional tools to get insight on the market or to preview the results before formulating an offer. In this case a different query running model may be used.

The query model executes multi-parameter user searches on the database in a single path. After the execution is complete, and in addition to the production of the requested results, the model also produces information about each parameter and how they affect the results, thereby allowing the user to interactively widen or narrow the scope of the results returned without re-executing the search on the database. This model extensively reduces the required system resources and speed of the process of arriving to the desired results.

The model includes creating a work table to store an intermediate result set. The work table may be created in a separate database on separate disks so as to save space on the main system. The separate database may be a non-logged database. A record about this new table, when it is created, may be added to a management table to perform housekeeping and cleanup routines. The work table may include various data, such as a PostID for identifying a post, a Summary Result for providing a summarized view of the results of the query, and a bit not-null field for each criteria parameter available.

The query may be formulated as an INSERT INTO instead of the standard SELECT. The SQL may be executed to insert intermediary rows into the query work table. In one embodiment, for each row inserted in the work table, the system will set each parameter bit column to 1 if the row matches that criterion and 0 if it does not. After the insert is complete a final retrieval is executed on the work table to return the maximum number of rows which equate to the total number of rows in the work table, and the filtering effect of each criterion which equate to the sum of each of the bit columns specifying how many records match that criterion. The user can interactively remove some or all the criterion of the original query and the system is able to produce the desired results without re-executing the query again. This model provides a very fast system for interactive queries over large databases that can be re-used in different scenarios.

When a potential merchant is a non-partner merchant, the system may perform automated searches of various available databases, either locally or remotely. In one embodiment, data is gathered on a regular basis from partner and non-partner merchants and stored in a global inventory database, for searching when non-partner merchants are identified as potential merchants. In another embodiment, the system will acquire data from non-partner merchants only when a non-partner merchant is selected for a given post, by accessing publicly available information regarding products and/or services offered by the non-partner merchants, directly from the merchant or through an intermediary service provider.

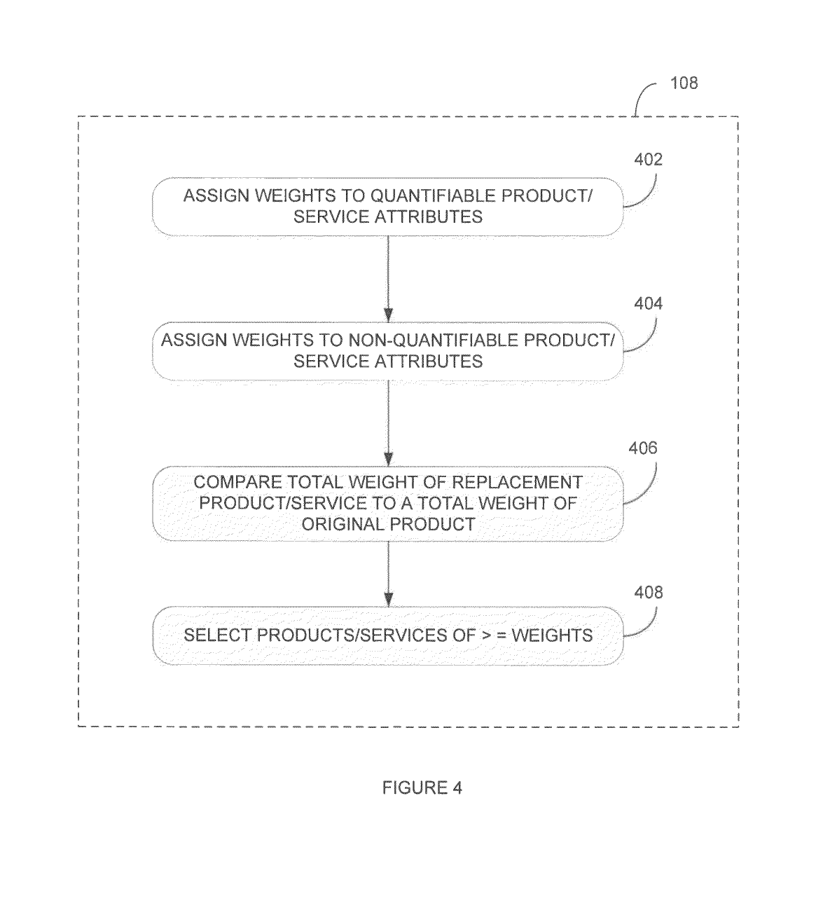

FIG. 4 is a flowchart illustrating an exemplary method of searching for bids from non-partner merchants 108. A comparable product/service is understood to be a product/service that can potentially replace the original product/service. It may be equal to the original product/service, or it may surpass the original product/service for some attributes and be inferior to the original product/service for other attributes. In order to be searchable, the products/services may be classified in accordance with one or more categories and sub-categories. For each category/sub-category, there may be many different attributes used in the comparison. Some of the attributes may be considered differentiators, i.e. they are the ones used to determine the outcome of the comparison. Differentiators may have varying weights associated thereto. Attributes that are quantifiable may be expressed as numerical values, with a predefined order for low values to high values. Attributes that are not quantifiable may have a predefined domain of values, also with a predefined order for low values to high values. Other attributes may simply be a characteristic that a product/service has or does not have.

In some embodiments, the system also calculates a maximum allowed price for the competing new products. This calculation may take into consideration the difference in features and is designed to make sure that not all better products are sent to the consumer, but only the ones that are within an acceptable threshold of price increases, aligning it with the original purchase price range.

For each product/service considered, the quantifiable product attributes are assigned a weight as a function of a value 402. The non-quantifiable product attributes are assigned a weight 404 as a function of the order of the attribute in the ordered domain, and the characteristic attributes are assigned a weight as a function of the presence of each characteristic attribute in the original product/service and whether or not it corresponds to a requirement by the consumer for a replacement product/service. The assigned weights are added up and compared to a weight for the original product/service 406. Products/services that have a total weight greater than or equal to that of the original product/service are selected as comparable products 408.

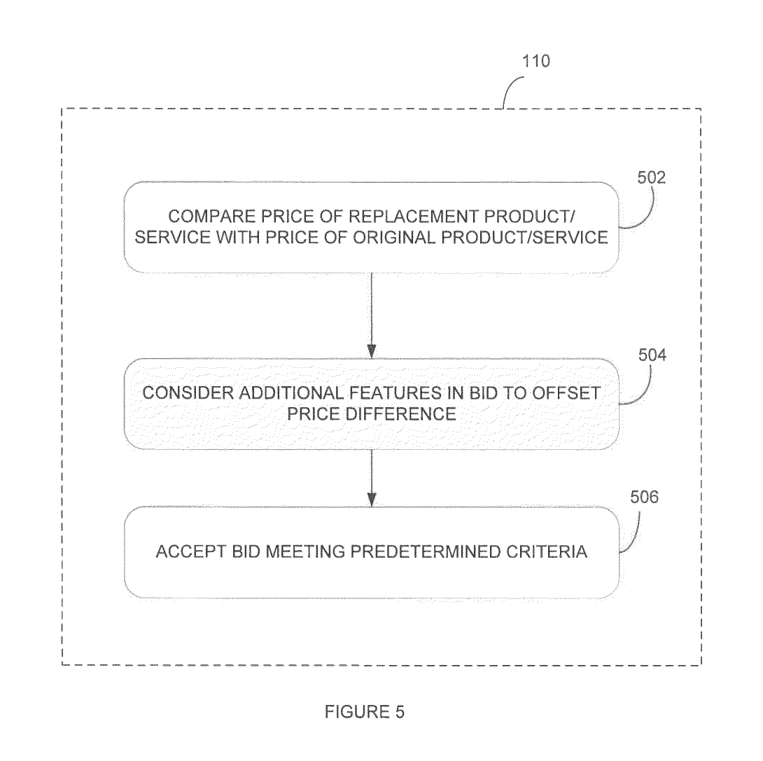

As per FIG. 1, any bids received, whether from partner merchants or non-partner merchants, are assessed 110 before deciding whether they constitute “better deals” than the original purchase. FIG. 5 is an exemplary method for performing this assessment. The price of the replacement product/service may be compared with the price of the original product/service 502. In some cases, this may be more complex than a straight comparison since a replacement product/service may be more expensive but still be a better deal due to a better quality or superior features. Conversely, a cheaper product/service may not necessarily be a better deal if the product/service is inferior to the original. Additional features may also be considered to offset a price difference 504. Examples of additional features are free parking, shuttle service, and other incentives that may increase the value of the bid or create an additional incentive for the consumer.

In some embodiments, the potential revenue generated to the system operator by an accepted bid, including costs of acquisition, special costs for completing the transaction, commission, return/cancellation fees, etc, may also be considered when determining if a bid is accepted and should be sent to the consumer.

Bids that are found to meet the set of predetermined criteria, as defined by the system operator, are accepted 506. Referring back to FIG. 1, accepted bids are provided to the consumer 112 while rejected bids are not 114.

In some embodiments, the bid processing method of FIG. 1 is iterative, i.e. if after completing the process there are no bids found for a post and there is still room to relax the values of the merchant selection criteria, step 104 will be redone in an attempt to find more merchants, and all the following steps will be repeated. In some embodiments, certain priorities are set for performing the bidding process iteratively. For example, in a first pass, only posts that are open for bids, have not yet received any direct bids, are set to stop receiving bids in the next 3 days, and have not been searched yet are processed. In a second pass, only posts that are open for bids, did not receive any direct bids, were created more than 1 day ago, and were never searched before are processed. In a third pass, only posts that are open for bids and have not yet received any direct bids are processed. Various other examples for setting processing priorities will be readily understood by those skilled in the art.

Accepted bids may be sent to the consumer via email, as a notification posted on a website, via text messaging, or using any other forms of communication available to the consumer. In some embodiments, the system may be configured to complete the full transaction of replacing the original purchase with a competing bid, including dealing with the merchant offering the competing bid and dealing with the merchant offering the original purchase. In an alternative embodiment, once the consumer receives the accepted bids and selects one to replace an original purchase, the system operator is no longer involved in the process and the consumer and merchants deal directly with each other.

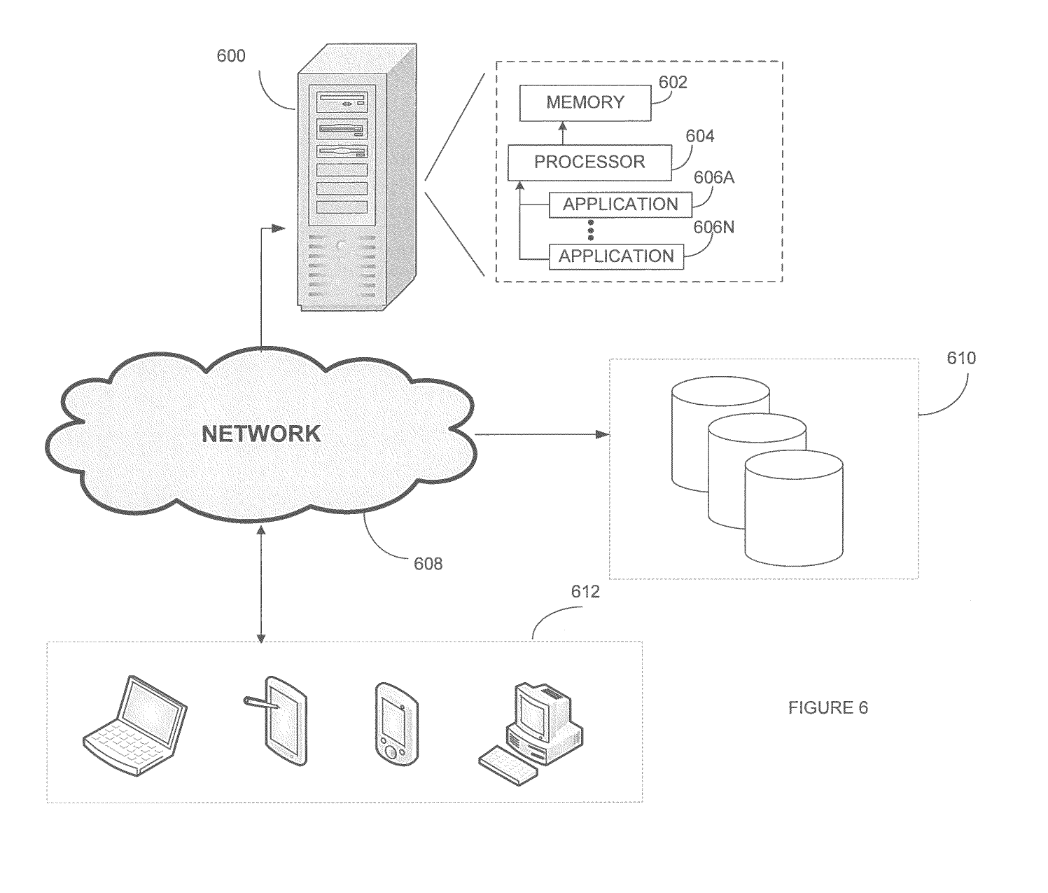

Referring to FIG. 6, there is illustrated a system for executing the online bidding system. One or more server(s) are provided remotely and accessible via a network 608. For example, a series of servers corresponding to a web server, an application server, and a database server may be used. These servers are all represented by server 600 in FIG. 6. The server 600 is accessed by a client device 612, such as a telephone, a computer, a personal digital assistant (PDA), an Iphone™, etc, via any type of network 608, such as the Internet, the Public Switch Telephone Network (PSTN), a cellular network, or others known to those skilled in the art.

The server 600 comprises, amongst other things, a plurality of applications 606a . . . 606n running on a processor 604, the processor being coupled to a memory 602. It should be understood that while the applications 606a . . . 606n presented herein are illustrated and described as separate entities, they may be combined or separated in a variety of ways.

One or more databases 610 may be integrated directly into memory 602 or may be provided separately therefrom and remotely from the server 600 (as illustrated). In the case of a remote access to the databases 610, access may occur via any type of network 608, as indicated above. The various databases described herein may be provided as collections of data or information organized for rapid search and retrieval by a computer. They are structured to facilitate storage, retrieval, modification, and deletion of data in conjunction with various data-processing operations. They may consist of a file or sets of files that can be broken down into records, each of which consists of one or more fields. Database information may be retrieved through queries using keywords and sorting commands, in order to rapidly search, rearrange, group, and select the field. The databases may be any organization of data on a data storage medium, such as one or more servers.

In one embodiment, the databases are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). An SSL session may be started by sending a request to the Web server with an HTTPS prefix in the URL, which causes port number “443” to be placed into the packets. Port “432 is the number assigned to the SSL application on the server. Identity verification of a user may be performed using usernames and passwords for all users. Various levels of access rights may be provided to multiple levels of users.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Frame buffer) Protocol.

The memory 602 accessible by the processor 604 receives and stores data. The memory 602 may be a main memory, such as a high speed Random Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc.

The processor 604 may access the memory 602 to retrieve data. The processor 604 may be any device that can perform operations on data. Examples are a central processing unit (CPU), a front-end processor, a microprocessor, a graphics processing unit (GPU/VPU), a physics processing unit (PPU), a digital signal processor, and a network processor. The applications 606a . . . 606n are coupled to the processor 604 and configured to perform various tasks as explained below in more detail. An output may be transmitted to a client device 612.

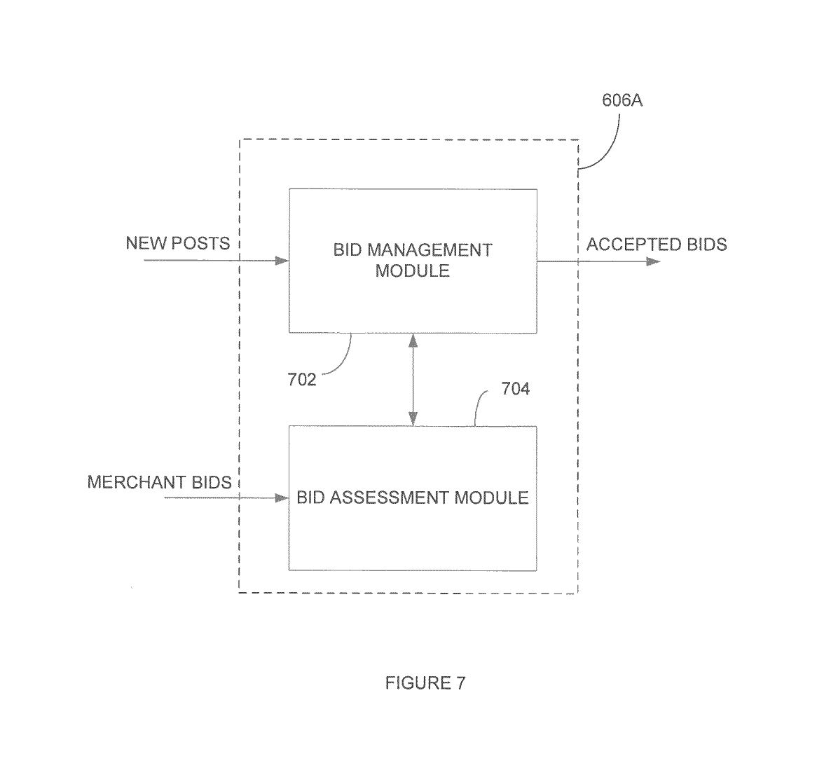

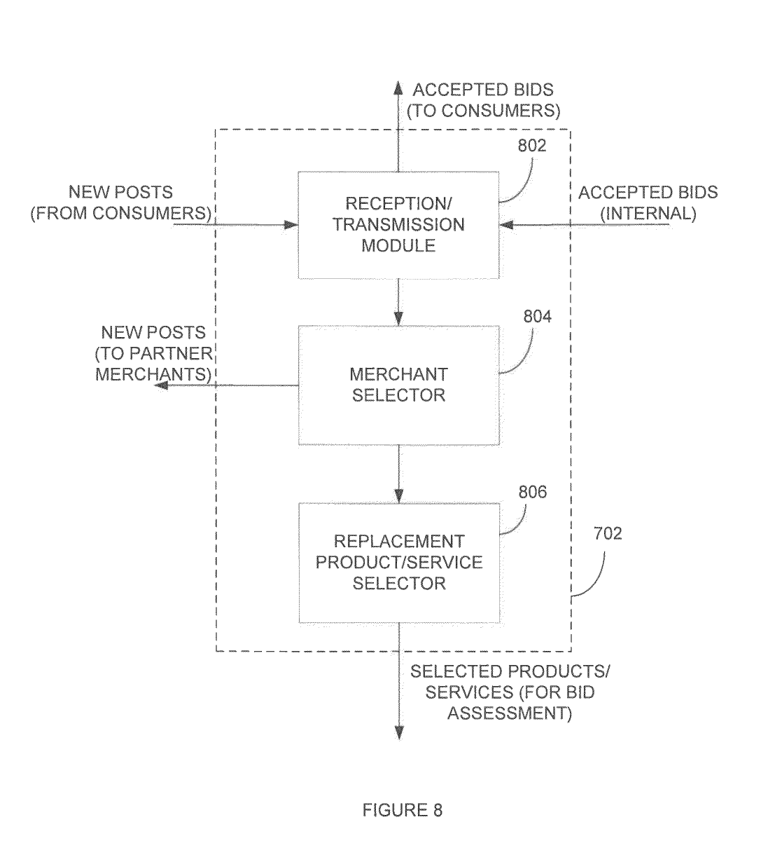

FIG. 7 is an exemplary embodiment of an application 606A running on the processor 604 for the bidding system described above. New posts are received by a bid management module 702. A bid assessment module 704 is operatively connected to the bid management module 702 and receives merchant bids. Accepted bids are output by the bid management module 702 to the consumer. FIG. 8 illustrates the bid management module 702 in more detail.

New posts are received from the consumers at a reception/transmission module 802. The posts are processed in the reception/transmission module 802 as per the method illustrated in FIG. 2, in order to extract data therefrom, validate data, and enter it into a database. In some embodiments, the reception/transmission module 802 is also adapted to determine if a post in the database is in a position to accept new bids. This determination may be done by verifying parameters associated with the post such as whether it is active, whether it is open for bids, whether the date and/or time for new bids has expired, etc. If it is deemed that the post cannot accept new bids, the module 802 will look to a next post for a similar assessment. Posts open for bids are provided to a merchant selector 804, configured to perform the steps illustrated in FIG. 3. If a partner merchant is selected, the posts are sent to the partner merchants or the partner merchants are advised of the existence of a new post open for bidding. Alternatively, the new posts are provided in a specific secure subsystem accessible to the partner merchants to consult, using the query model described above, at their discretion. If a non-partner merchant is selected, a replacement product selector 806 is instructed to perform the steps illustrated in FIG. 4 in order to identify potential replacement products/services.

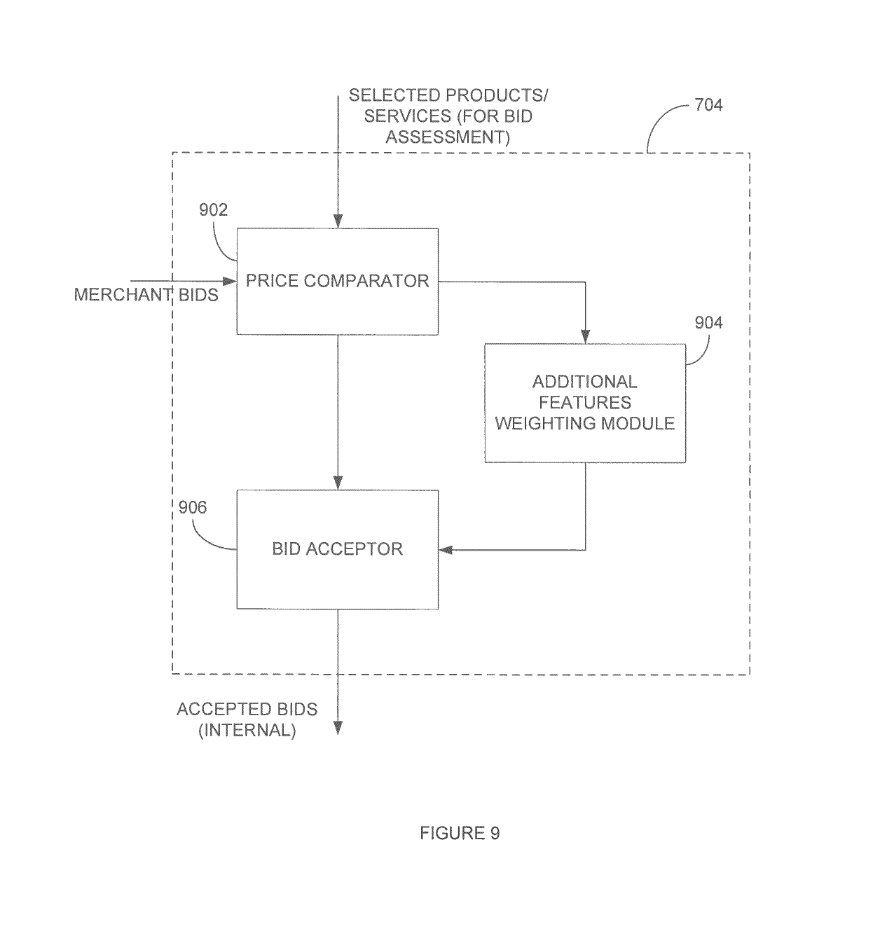

As per FIG. 9, the bid assessment module 704 receives merchant bids from partner merchants and selected products/services from the replacement product/service selector 806 at a price comparator 902. This step of the price is used to provide the consumer with bids that are truly competitive, either because the price is better than the original purchase, or the price is slightly higher but additional features may offset this price difference. The price comparator 902 and an additional features weighting module 904 both feed into a bid acceptor 906, where the ultimate decision as to whether a bid should be sent to the consumer is taken. Accepted bids are returned to the bid management module 702 and provided to the consumer via the reception/transmission module 802.

As indicated above, the bidding system may be designed to work for a wide variety of purchases. Alternatively, separate bidding systems may be provided for different types of purchases. For example, a system may be provided only for hotel reservations, another system may be provided only for electronic devices, etc. In one embodiment, each application (606A, . . . , 606N) running on the processor 604 is adapted for a specific type of purchase. Configuration parameters such as the algorithms used to extract data by the reception/transmission module 802, to select potential merchants by the merchant selector 804, and to select replacement products/services by the replacement product/service selector 806 may be specific to the type of purchase the application corresponds to. Similarly, configuration parameters for the price comparator 902, the additional features weighting module 904, and the bid acceptor 906 when assessing bids may also be specific to the type of purchase the application corresponds to. The complexity of the rules and logic running in a given application will depend on the different categories and/or sub-categories considered by the system, and the different criteria considered to compare products and assess bids.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. It should be noted that the present invention can be carried out as a method, can be embodied in a system, a computer readable medium or an electrical or electro-magnetic signal. The embodiments of the invention described above are intended to be exemplary only. The scope of the invention is therefore intended to be limited solely by the scope of the appended claims.

1. A computer-implemented method for managing competing bids from multiple merchants for an original purchase, the method comprising executing program code by a processor for:
receiving information in electronic form regarding the original product or service, the information comprising matter specific properties associated with the original product or service;
filtering the multiple merchants in accordance with the matter specific properties to identify potential merchants suitable for providing a competing bid to the original product or service;
transmitting a communication to selected merchants to advise that the original product or service is open for bidding;
receiving bids from the selected merchants for the original product or service;
filtering the bids from the selected merchants in accordance with a set of predetermined criteria; and
transmitting to a consumer only accepted bids for consideration.

2. The method of claim 1, wherein receiving information regarding the original product or service comprises:
receiving the information in an unknown format;
extracting data from the information;
validating the data as extracted; and
entering validated data into a storage medium.

3. The method of claim 1, wherein filtering the multiple merchants comprises considering partner merchants and non-partner merchants, and wherein transmitting a communication to selected merchants comprises only advising selected partner merchants of the original product or service as open for bidding.

4. The method of claim 1, wherein filtering the multiple merchants comprises selecting merchants that offer comparables to the original product or service.

5. The method of claim 1, wherein filtering the multiple merchants comprises performing a first selection process with a first set of selection criteria, assessing a number of potential merchants, and performing a second selection process with a second set of selection criteria less restrictive than the first set of selection criteria when the number of potential merchants is less than a predetermined threshold.

6. The method of claim 1, wherein filtering the bids from the selected merchants comprises considering multiple features of the original product or service as the predetermined criteria.

7. The method of claim 6, wherein considering multiple features comprises assigning varying weights to the multiple features.

8. The method of claim 7, wherein assigning varying weights comprises assigning weights to quantifiable features and assigning weights to non-quantifiable features.

9. The method of claim 8, wherein filtering the bids comprises comparing a total weight of a replacement product or service to a total weight of the original product or service.

10. The method of claim 1, wherein filtering the bids comprises comparing prices between the original product or service and a replacement product or service and considering additional features to offset a price difference.

11. A system for managing competing bids from multiple merchants for an original product or service, the system comprising at least one computer server communicable with at least one client computing device over a network, the server having a processor and a memory having executable program code stored thereon and executable by the server, the program code comprising instructions for:
receiving in electronic form information regarding the original product or service, the information comprising matter specific properties associated with the original product or service;
filtering the multiple merchants in accordance with the matter specific properties to identify potential merchants suitable for providing a competing bid to the original product or service;
transmitting a communication to selected merchants to advise that the original product or service is open for bidding;
receiving bids from the selected merchants for the original product or service;
filtering the bids from the selected merchants in accordance with a set of predetermined criteria; and
transmitting to a consumer only accepted bids for consideration.

12. The system of claim 11, wherein receiving information regarding the original product or service comprises:
receiving the information in an unknown format;
extracting data from the information;
validating the data as extracted; and
entering validated data into a storage medium.

13. The system of claim 11, wherein filtering the multiple merchants comprises considering partner merchants and non-partner merchants, and wherein transmitting a communication to selected merchants comprises only advising selected partner merchants of the original product or service as open for bidding.

14. The system of claim 11, wherein filtering the multiple merchants comprises performing a first selection process with a first set of selection criteria, assessing a number of potential merchants, and performing a second selection process with a second set of selection criteria less restrictive than the first set of selection criteria when the number of potential merchants is less than a predetermined threshold.

15. The system of claim 11, wherein filtering the bids from the selected merchants comprises considering multiple features of the original product or service as the predetermined criteria.

16. The system of claim 15, wherein considering multiple features comprises assigning varying weights to the multiple features.

17. The system of claim 16, wherein assigning varying weights comprises assigning weights to quantifiable features and assigning weights to non-quantifiable features of the original product or service.

18. The system of claim 17, wherein filtering the bids comprises comparing a total weight of a replacement product or service to a total weight of the original product or service.

19. The system of claim 11, wherein filtering the bids comprises comparing prices between the original product or service and a replacement product or service and considering additional features to offset a price difference.

20. A non-transitory computer readable medium having encoded thereon program code executable by a processor for managing competing bids from multiple merchants for an original purchase, the program code comprising instructions for:
receiving information in electronic form regarding the original product or service, the information comprising matter specific properties associated with the original product or service;
filtering the multiple merchants in accordance with the matter specific properties to identify potential merchants suitable for providing a competing bid to the original product or service;
transmitting a communication to selected merchants to advise that the original product or service is open for bidding;
receiving bids from the selected merchants for the original product or service;
filtering the bids from the selected merchants in accordance with a set of predetermined criteria; and
transmitting to a consumer only accepted bids for consideration.
